(19) United States
(12) Patent Application Publication
(10) Pub. No.: US 2004/0108042 A1
(43) Pub. Date: Jun. 10, 2004

(54) Method for producing solid materials from plant material, material produced according to said method, use of the material in addition to a system for carrying out said method

(76) Inventor: Christoph Affentranger, Grabenstrasse (CH)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/466,033

(22) PCT Filed: Jan. 11, 2002
(86) PCT No.: PCT/CH02/00016

(30) Foreign Application Priority Data
Jan. 12, 2001 (CH) 40/01

(51) Int. Cl. B32B 31/00

(52) U.S. Cl. 156/153; 156/336; 435/277

(57) ABSTRACT

The invention relates to a method for producing solid materials, particularly building materials, wherein vegetal source material is ground, fermented and at least partially dried. The vegetal source material is ground into fine grains, fermented by adding microorganisms, preferably yeast, and dried. Non-fermenting parts of the vegetal source material are bonded when drying by substances from the microorganisms, so that a solid ecologically safe material can be produced without conventional adhesives.

This invention relates to a method as described in the introduction to claim 1.

The prior art describes numerous methods for the manufacture of a solid material from plant raw material that has been ground into small particles. The goal of these methods is always to bind materials that are in the form of small particles or are otherwise relatively worthless into a larger object, a compound material, which then has better properties than merely the sum of the raw materials without additional binding agents. Emphasis has thereby been placed on a wide variety or products in which glues are added as adhesives in one form or another (such as chipboard or fiberboard, but also extrusions of mixtures of thermosetting plastics and plant raw materials, to cite only a few examples).

However, glues have the significant disadvantage that they dry out over a very long period of time. They also emit gases (such as formaldehyde, for example) that are health hazards. An additional disadvantage is that such glue-based materials, of the types that are frequently used for the furniture industry, are very difficult and expensive to recycle when they reach the end of their useful lives on account of the glue they contain. The incineration of these materials likewise causes major problems on account of the toxic vapors that are emitted by the glue. An added difficulty is that glues are expensive. A further, very important disadvantage of these methods based on glue is that the raw material cannot always be as small as desired for large-scale industrial production, because as the raw material becomes smaller, it becomes increasingly difficult in an industrial process to provide small particles with sufficient glue so that they can still be adhesively connected to the other particles. One of the reasons is that the fibers or chips must have certain characteristics such as size or type of surface so that the technical characteristics of the finished products can be kept constant to a certain degree, and ultimately so that the product does not consist solely of glue. Therefore, precisely in the manufacture of boards and panels from wood, the primary material is supplied by third parties in the form of trunks or branches and not, as might be expected, in the form of wood chips. However, waste wood in particle sizes as small as chips is available in large quantities in the woodprocessing industry, although it can be used only seldom, if at all, for the manufacture of boards, panels, paper or similar objects, and therefore must frequently be incinerated.

The disposal of plant material of this type, which is frequently left over from other industrial processes in the form of residues, is a challenge for many branches of industry. It is also known that some plant materials have self-adhesive properties when they are processed in this manner, thanks to the resins and saps they contain. These self-adhesive properties are utilized in the manufacture of certain fiberboards that are made of wood and grasses. In the industrial world, however, there is some doubt about whether this method can be used on an industrial scale to achieve sufficiently high strengths.

Methods are also known, although they are not used in the industry for the manufacture of solid materials, especially of materials for the construction industry and for other applications, in which the glue is formed naturally in the material itself by the

microorganisms that are obtained during a fermentation. In these methods, waste materials such as residues from the furniture industry are used, or other mixtures of similar compost-like materials such as corn, branches, grass and chicken feathers are used as the raw materials. These components are ground up and mixed together. The mixture is fermented and allowed to stand for several days to cure. The compound obtained in this manner can be used for various purposes, such as for the manufacture of pallets or moldings, by homogenizing the compound and placing it in a mold under pressure by injection molding. The object obtained in this manner is then cured by drying. The objects manufactured using this method have the advantage that, if and to the extent that the raw materials are suitable, disposal presents no problems and they can be recycled naturally and economically. A disadvantage is that the methods of the prior art for the manufacture of such items take several days or even weeks, or in any case a relatively long time. The characteristics of the products manufactured using these methods are practically impossible to control, because the raw materials do not represent a uniform group of raw materials, and moreover are generally procured from a wide variety of sources in quantities that are too small to be of interest for industrial use. Nor is there any indication of how an industrial process for the manufacture of panels or moldings would have to be configured. Accordingly, the values of the finished products that are also of importance for industrial applications, such as strength, porosity and useful life, are generally unknown or known only approximately. In a method that is widely used in the food industry, however, plant raw materials are ground, fermented and then dried or cured for the manufacture of bread. Salt dough of the type that is used for the molding crafts items is classified somewhere between food and a construction material, although it is used only in small quantities. However, the food industry does not manufacture any materials that have specified strength characteristics.

The object of this invention is a method to manufacture a processable material made of ground plant raw materials that overcomes the disadvantages described above. In the ideal case, the method should be suitable for industrial production in a continuous process. It should also be economical, environmentally acceptable and not require the use of conventional adhesives. An additional object of the invention is the use of a material manufactured as taught by the invention. The material should be a material that can be used in a wide variety of applications, and should be suitable for use in the construction, packaging, furniture, aircraft, automobile and shipbuilding industries, as well as for use by smaller-scale industries and craftsmen. In the best case, the material should also be easy to recycle, or even be compostable, and its incineration should not present environmental problems that exceed those presented by the incineration of a comparable amount of wood. The technical properties of the material should be known and reproducible. The compression strength of this material should be at least 0.1 N/mm² (preferably more than 2.0 N/mm²) and its internal bond strength should be at least 0.01 N/mm² (preferably more than 0.2 N/mm²), whereby these values should be valid for a moisture content of the material of less than 3%. It should be possible to process this material in a manner similar to the methods used for processing wood, i.e. it should be possible to process it by sawing, adhesive bonding, grinding, drilling and boring. Moreover, at least one method should be known for the manufacture of a highly porous variant of this material (pore volume in the best case more than 15%). The porosity of the material should represent one possible characteristic of the material, although a specified porosity is not mandatory. It should be possible to manufacture the material in the form of curved or flat boards or panels, moldings, tubes or elbows, in the best case in large formats.

The invention teaches that this object can be accomplished as disclosed in claim 1. In developments of the invention, the method is preferably characterized by the fact that:

a) Plant substances such as wood or straw, for example, but also corn starch are finely ground (if and to the extent that the size of the particles has not already been reduced by previous processes), preferably to a particle size of less than 0.5 mm in diameter,

b) The particles obtained in the manner described above are brought into contact with suitable microorganisms (for example yeast fungi or bacteria), which can be done inside or outside a fermenter,

c) The microorganisms reproduce in a fermenter, for example a batch fermenter or a tubular flow reactor, by digesting some or all of the available plant components, which can occur under controlled conditions of temperature, pressure and humidity.

d) One or more additives can optionally be added to the viscous compound obtained in the manner described above to influence various characteristics of the end product, such as compression strength or tensile strength, but also to make the material resistant to destructive insects that can attack the finished material,

e) Liquid can optionally be extracted, mechanically and/or chemically for example, from the viscous compound,

f) The viscous compound obtained in the manner described above can be optionally aerated, mechanically and/or chemically for example,

g) The viscous compound is poured into a mold or is deposited on a material,

h) The viscous compound is dried in one or more steps, for example by heating with microwaves or radio waves,

i) The partly or fully dried compound is removed from its mold,

j) and the partly or fully drive compound is fabricated into a product, i.e. it can be sawed or cut to shape and reprocessed.

The biological construction or building material manufactured in the manner described above is suitable for building furniture, wooden structures, for interior construction in buildings, in the manufacture of motor vehicles, aircraft and ships, for thermal and acoustical insulation in buildings and for use as a packing material. The invention is based on the knowledge that bread that has become hard and dry would theoretically be suitable for use as a construction and insulation material for various purposes, of course overlooking possible ethical objections to the use of a basic food as a construction or building material. The porous to bubbly, partly three-dimensional network structure of bread makes it specifically lightweight. Moreover, hard, dry bread is very stable, and can be preserved for a very long time as long as it does not become wet, such as zwieback, for example. An additional special characteristic of hard bread is its absorptive capacity. It can be relatively easily soaked in a liquid, and after it has dried out the bread becomes hard again. And finally, bread decomposes biologically without creating any environmental problems. In other words, the disposal of bread does not represent a major problem.

Baking technology can surprisingly also be used to process a dough that basically contains materials that are inedible, such as finely ground wood in the form of sawdust, fine wood chips or other plant components, such as, for example, straw or even a mixture of different plants.

Preferably, however, the plant components are of one single type, such as wood that originates more or less exclusively from spruce trees or from beech trees. However, these materials can be used very efficiently in construction or as a building material. The various known technologies for processing and aerating dough used in the baking industry can be transferred without modification to a dough that contains wood flour, as extensive tests have shown. The advantageous characteristics of bread, namely its fine three-dimensional matrix, can thereby be transferred more or less intact to a product having the composition described above (See FIGS. 2 and 3). The invention therefore consists of the use of biological, chemical and mechanical processes of the type conventionally used for the manufacture of bread to produce a porous to bubbly, partly three-dimensional network structure of a biological construction and building material. The dough consisting of biological material is thereby placed in molds and dried in the molds, so that finished products are obtained in the form of boards, panels, balls, bars or any other desired molded shapes. Likewise, the dough can also be deposited on a suitable material and baked together with the substrate material, so that it then adheres to the substrate material and this material is part of the finished end product, in which case no unmolding is necessary. As a result of appropriate modifications to the dough, namely modifications of its components and their characteristics, and as a result of the consistency of the dough that is achieved by means of specific processing methods, the characteristics of the baked finished product can be controlled within broad limits. This method can be used to produce a very large number of combinations with a wide variety of potential characteristics.

In the simplest variant, finely ground wood in the form of fine wood chips or sawdust is pulverized into a fine-grain wood flour. Water and a yeast or fermentation bacteria that form lactic acid or acetic acid, for example, are then added to this wood flour and the compound is mixed to form a homogeneous dough. During this mixing process, air can also be injected mechanically, in exactly the same manner as for the preparation of a bread dough. The finished wood flour dough is then allowed to ferment. The fermentation process of the yeast fungi or fermentation bacteria releases gases into the dough which aerate the dough so that it develops a porous structure. This process can be promoted chemically by also adding baking powder to the dough. However, air can also be mechanically injected under pressure or a gas can be injected into the dough, as is frequently done in the food processing industry. Then the dough is poured into a desired mold or deposited on a suitable material and baked, i.e. cured and hardened by heating. A specific application of pressure to the molding compound is unnecessary, although it may be appropriate for certain applications, for example, if the objective is to reliably fill molds that have relatively inaccessible spots with dough and to fill them all the way to the top, or if the characteristics of the material that is ultimately to be produced can be improved by a pressure treatment of the dough. The cured, baked wood flour molding can then be removed from the mold or combined with the backing materials and processed further as necessary.

Numerous solid, liquid or gaseous materials can also be added to the dough, individually or in combination, to modify the properties of the end product to be baked, the properties of the construction and building material or the properties of the dough itself. For example, salts can be added to increase fire resistance. Other particularly appropriate flameproofing agents that can be added to the dough include borax, zinc

borate or silica dust. A variety of chemicals can also be added to protect the cured product from attacks by destructive fungi and insects. Suitable additives for this purpose include organic acids, preferably low-molecular-weight organic acids such as acetic acids, citric acid, tartaric acid, formic acid, lactic acid, propionic acid, benzoic acid, sorbic acid and salicylic acid or other acids, although acetic acid is particularly well suited for this purpose. These acids or other liquids can be added to the dough prior to molding and mixed homogeneously with it, or added only on the surface of the dough, e.g. by spraying. Alternatively, chips and fibers of plants or adhesives can be added to improve the properties of the product against fracture, for example to improve its tensile strength and thus its breaking strength. These modifications can be accomplished, for example, by adding textile fibers, hard fibers such as flax, banana fiber, coconut fiber, hemp fiber, tree fiber, straw and/or papers, cardboard and textiles etc. Metals in various forms can also be added to make the product magnetically or electrically conductive. Fats, resins and oils as additives can be used to soften the product. All sorts of synthetic materials can also be added in a wide variety of forms. Carbohydrates in forms such as sugars and starches, enzymes, catalysts and alcohols as additives can be used to control and optimize the fermentation process, i.e. the growth of the microorganisms. Basically, any biological material can be used as an additive to modify the properties of the material. Materials that can be used for this purpose include leaves, branches, needles, roots, fruits, stalks, husks, pods, root tubers, flowers, rinds, grasses, straw, cereal grains, weeds and fibers of all types. But the category of biological materials includes more than just plant materials. Animal substances can also be used as additives, such as feathers, scales, wool, leather, animal skins, nematodes etc. Finally, if necessary, mineral binders such as gypsum or clay can also be added to the dough as necessary, to influence the characteristics of the finished product in the desired direction. There are a great many possible variants for the addition of auxiliary materials, and the additives mentioned here purely by way of example do not represent an exhaustive list. The additives can thereby account for a significant portion by weight of the finished product. The biological raw material, however, interacts with the yeast or the fermentation bacteria as a promoter for the fermentation.

It is possible to cure doughs of different compositions in layers or are otherwise spatially separated, on top of each other or next to one another, and in this manner to produce laminated or partly separated materials with properties that are different depending on the layer or location. The dough or the doughs can also be treated with various liquids before, during or after the heating, or they can also be saturated to advantageously influence the baking or curing process or the characteristics of the end product. For baking, the dough can either be placed in molds or deposited on a backing material, with which it can bond automatically or with which it can be connected by gluing, so that the backing material becomes an integral part of the finished product. The backing material for the dough can be a fiberboard panel, for example. Also conceivable are sandwich structures, the spaces in which can be filled with wood dough and then heated as a unit, as a result of which the wood dough in the spaces is baked. The baked finished products, regardless of their format or shape, can be processed using known technologies, and in particular they can be soaked in liquids. It is clear that boards and panels manufactured in the manner described above can also be constructed by means of adhesives or mechanical connections to form multiple-layer, sandwich-type boards and panels. All mechanical processing methods such as drilling, milling, sawing, grinding etc. can also be used. If the dough and thus the baked finished

construction or building material does not contain flammable substances that form a three-dimensional structure in the interior of the construction or building material, the biological material can subsequently be subjected to a controlled combustion, so that the only thing that remains after the combustion is this three-dimensional structure consisting of non-combustible material. Of course, the construction and building materials can also be subjected to a plurality of processing steps. After curing, the construction and building material can be coated, for example, with an additional coating consisting of an identical dough or another type of dough and then baked again. The construction and building materials manufactured in this manner can be coated or covered with various materials such as wood panels or veneers. A veneered panel manufactured according to this method and consisting of wood flour and yeast has stability characteristics similar to those of a chipboard, although it is only about half as heavy and can be manufactured significantly more economically, not least because the primary material, in the case of sawdust and wood chips, is waste wood, the disposal of which is becoming increasingly complex and expensive, if suitable incineration facilities, such as power plants that burn wood chips, are not available or if the waste wood cannot be used for another purpose with reasonable economy and efficiency.

The advantageous effect of the invention consists of the production of a solid material that has the special characteristics described below and a method that differs in its simplicity and economy from the methods of the prior art for the manufacture of a solid material from plant products in the form of small particles, such as by gluing. The properties of the solid materials manufactured according to this method differ from those of products currently on the market in particular on account of the absence of glues, which means that they are significantly easier to dispose of, except for a few synthetic additives, e.g. by composting, by recycling or incineration.

Furthermore, plant ingredients in the form of small particles, of types that have previously been difficult to use for the manufacture of solid materials, can be used for the manufacture of these materials. The invention thereby solves one waste problem that confronts the wood processing industry, but other industries as well, which have large amounts of residual material from plants. The materials manufactured using the method taught by the invention also have, depending on the recipes (with or without additives), the fermentation time and the microorganisms used, properties that are comparable to the properties of common products such as fiberboard, chipboard etc. This comparability is due above all to the compression strength of this material, which is at least 0.1 N/mm² (preferably more than 2.0 N/mm²), its internal bonding strength of at least 0.1 N/mm² (preferably more than 2.0 N/mm²) and its thermal conductivity of less than 0.9 W/mK (with a porosity of at least 30% or more), whereby these values are valid when the material has a moisture content of less than 3%. The material can be processed in a manner similar to wood, i.e. it can be sawed, glued, ground, bored and drilled. A porosity of up to 50% and more can also be produced. However, the porosity of the material can be reduced by suitable measures (such as by pressing before drying). The material can be manufactured in the form of curved or flat boards or panels, moldings, tubes or elbows. It is likewise possible, by the addition of the widest possible variety of additional materials and combinations thereof, even in determined three-dimensional arrangements, to influence the quality of the building and construction materials manufactured within broad ranges.

The strength of the finally hardened material apparently depends on the organization of the microstructure of macromolecules, dispersed parties and larger solids produced by the gases that are generated by the yeast or bacteria and/or on the metabolic products (primarily polysaccharides) produced by the yeast or bacteria and/or to the cellulose constructed by the yeast or bacteria.

The invention is explained in greater detail below with reference to the accompanying drawings, in which:

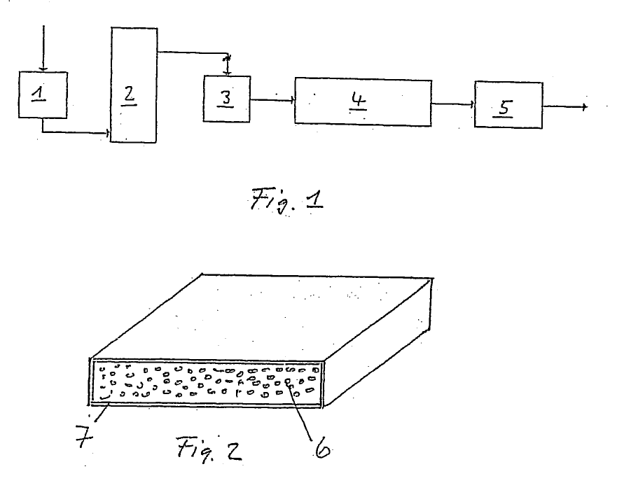

FIG. 1 is a schematic diagram that illustrates the individual steps of the method, and

FIG. 2 is a three-dimensional schematic representation of a segment of a material taught by the invention as shown in cross section.

While the description presented above indicates the composition of the construction and building material in merely qualitative terms, one recipe is given below by way of example:

10 kg to 30 kg of corn starch are dissolved in 60 to 100 kg of water. 4 kg to 10 kg of dry yeast are added as additional biological ingredients. This mixture is then left to ferment for one hour at 10° C. to 40° C., preferably at approximately 22° C. to 28° C. 30 to 50 kg of extremely fine wood dust is then added together with 20 kg to 35 kg of water and then the mixture is thoroughly agitated. Finally, 5 kg to 20 kg of baking powder are added. The homogeneous, viscous dough compound obtained after thorough agitation can then be poured into a mold, whereupon it is baked at a temperature of 40° C. to 700° C., preferably between 100° C. and 220° C., until it is completely dried and hardened. This process can be carried out in a circulating air oven, although a microwave oven is even better suited to the process.

In a second possible recipe, 10 kilograms of spruce wood with a grain size of less than 0.5 mm diameter are mixed in a fermenter with 20 kilograms of water, yeast is added

and this mixture is allowed to ferment at a temperature of approximately 10° C. to 40° C., preferably between approximately 22° C. and 28° C., for 2 to 72 hours, preferably for approximately 20 to 28 hours, with constant kneading. The homogeneous, viscous dough obtained after thorough agitation can then be poured into a mold, whereupon it is baked at a temperature of 40° C. to 700° C., preferably between 100° C. and 220° C., until it is completely dried and hardened. This process can be carried out in a circulating air oven, although a microwave oven is even better suited to the process.

The method is particularly attractive for the manufacture of plastically molded biological construction and building materials, if it can be run continuously or quasi-continuously, which means that at least two or more steps in the method can be carried out continuously one after the other. In the plant that is illustrated schematically in FIG. 1, there is a device 1 for the performance of the method for the grinding of the plant primary material, a device 2 for fermentation, a device 3 for reprocessing, a drying apparatus 4 and a device 5 for reprocessing. The plant preferably includes an extruder, upstream of which there is a container with an agitator, essentially in the form of a conventional dough machine, as well as a heated hollow profile which is located downstream of the extruder. In the container, first the finely ground wood is mixed with water and yeast fungi or fermentation bacteria to form a homogeneous dough, after which this dough is allowed to ferment. Then the dough is placed in the extruder, in which it is pressed into a hollow profile using an extrusion process. This profile can be shaped, for example, so that it has a flat, rectangular inside cross section, so that a panel 6 as illustrated in FIG. 2 can be molded in it. The panel 6 can be provided with a veneer 7 and can be used, for example, in the construction of furniture and interior

paneling. The hollow profile, however, can also have an altogether different cross section, such as a circular inside cross section for the manufacture of round bars, or a polygonal, an H-shaped or T-shaped inside cross section for the manufacture of corresponding profiles, as well as a semi-circular cross section for the manufacture of channels etc. The dough is pressed into this profile, where it is baked by applying heat and slowly extruded into the desired shape. As soon as it is guaranteed that the baked construction element, i.e. the workpiece in the hollow profile, has developed a stable shape, it is pushed into a zone of the hollow profile where the hollow profile is initially provided with a few small holes, whereby this zone makes a gradual transition into a perforation with increasingly larger holes. In this perforated zone of the hollow profile, the just baked construction and building material is exposed to microwave radiation, so that the remaining water content is vaporized through the perforations, while the construction and building material, which by this time has acquired a stable shape, continues to be pushed forward in the perforated hollow profile until it is finally baked and dried and exits the mouth of the hollow profile, after which it can be cut to the desired length.

This construction and building material is suitable for a wide variety of applications. If it is manufactured in a porous variant, one of the most obvious uses is in the construction industry, where large quantities of insulating material in the form of sheets or panels are required. The material is suitable for use as insulation on account of its bubble structure. It is lightweight, can be preserved for long periods, is economical to manufacture and has a very good insulation value. In the furniture industry, the construction and building material, if it is veneered, for example, can be used as a replacement for conventional chipboard panels. It is approximately 50% lighter in weight and cheaper to manufacture than conventional chipboard panels. This material also performs well when it is used as packing material, as in the mechanical equipment industry, for example. It can be

provided in suitable shapes, so that sensitive equipment can be packed safely and securely in cardboard boxes or in wooden crates by matching the shape of the packing material to the shapes of the equipment to be packed. In that case, the wooden crates can also be manufactured from the material claimed by the invention. The material is particularly suitable for use as packing material on account of its light weight, its stability and the absence of problems presented by its disposal. Its light weight makes it suitable for use in the automotive, shipbuilding and aviation industries, in particular for interior fittings.

1. Method for the manufacture of solid materials, in particular construction materials, whereby plant raw material is ground, fermented and at least partly dried, whereby unfermented portions of the plant raw material are glued together by substances of the microorganisms, characterized by the fact that the plant raw materials are fermented and dried through the addition of microorganisms, and that the fermentation period is less than 72 hours and the solid material is porous after drying.

2. Method as claimed in claim 1, characterized by the fact that the plant raw material is wood or straw, or a mixture of the two.

3. Method as claimed in claims 1 or 2, characterized by the fact that the fermentation is conducted with suitable fungi, preferably yeast or fermentation bacteria.

4. Method as claimed in claim 3, characterized by the fact that the yeast is cultivated on finely ground wood by the addition of substances that promote its growth, in particular starches or xylose on finely ground wood, and the wood is fermented with this cultivated yeast.

5. Method as claimed in one of the claims 1 to 4, characterized by the fact that the plant raw material is ground to an average particle size smaller than 1 mm, preferably smaller than 0.5 mm.

6. Method as claimed in one of the claims 1 to 5, characterized by the fact that the drying is carried out with microwaves or radio waves from 1 MHz to 3.75×10¹⁴ Hz, preferably in the range of 5 to 20 MHz and 2000 to 2800 MHz.

7. Method as claimed in one of the claims 1 to 6, characterized by the fact that an additive is added to the raw material.

8. Method as claimed in claim 7, characterized by the fact that the additive is in the form of fibrous material.

9. Method as claimed in claim 7, characterized by the fact that the additive is a flame proofing agent.

10. Method as claimed in one of the claims 1 to 9, characterized by the fact that the fermentation period is less than 24 hours.

11. Method as claimed in claim 10, characterized by the fact that the fermentation period is selected so that the result is an essentially deformable material.

12. Method as claimed in one of the claims 1 to 11, characterized by the fact that the fermented raw material is dried and solidified in a mold.

13. Method as claimed in one of the claims 1 to 12, characterized by the fact that prior to heating, pores are formed by gases that are generated during the fermentation or with chemical substances or by the introduction, in particular the injection, of gas.

14. Material manufactured according to the method disclosed in claim 1, characterized by the fact that the strength of the finished, cured material depends on the organization of the microstructure of macromolecules, disperse particles
